(19) United States
(12) Patent Application Publication
(10) Pub. No.: US 2024/0049084 A1
(43) Pub. Date: Feb. 8, 2024

(54) SYSTEMS AND METHODS FOR CHANGING COMMUNICATION LINKS FOR MULTI LINK DEVICES ON MOBILE WIRELESS LOCAL AREA NETWORKS

(71) Applicant: HUAWEI TECHNOLOGIES CO., LTD., Shenzhen (CN)

(72) Inventors: Stephen MCCANN, Rownhams (GB); Michael Peter MONTEMURRO, Toronto (CA)

(21) Appl. No.: 17/882,741

(22) Filed: Aug. 8, 2022

(51) Int. Cl. H04W 36/08; H04W 36/32

(52) U.S. Cl. CPC H04W 36/08; H04W 36/32

(57) ABSTRACT

The present disclosure relates to multi-link devices (MLDs) including access point (AP) MLDs and non-AP MLDs, and specifically modules, systems and methods for changing a first communication link between a first affiliated station (STA) of a non-AP MLD and a first affiliated AP of an AP MLD to a second communication link between the first affiliated STA of the non-AP MLD and a second affiliated AP of the non-AP MLD, while maintaining a third communication link between a second affiliated STA of the non-AP MLD and a third affiliated AP of the AP MLD. More specifically, the present disclosure provides modules, systems and methods for changing an association of a communication link independent of other communication links allowing for continuous connectivity between a non-AP MLD and an AP MLD.

### TECHNICAL FIELD

The present disclosure relates generally to multi-link devices on wireless networks, and in particular, to changing communication links for multi-link devices on wireless networks.

### BACKGROUND

Multi-link devices (MLDs) are network elements that communicate with peer MLDs over multiple communication links. A MLD that provides access point (AP) functionality is commonly referred to as an AP MLD. A non-AP MLD uses affiliated stations (STAs) for communication over a wireless medium with an AP MLD that in turn uses affiliated APs.

A MLD can support multiple radios operating simultaneously, each radio operating within one or more frequency bands. MLDs can establish a connection with other MLDs across multiple radios with each connection referred to as a communication link.

Wireless local network (WLAN) standards, such as Institute of Electrical and Electronics Engineers (IEEE) 802.11, can be configured for MLDs to be used in a variety of modes of operation including where a non-AP MLD and AIP MLD operate in a multi-link operation (MLO) mode wherein the devices communicate over multiple, independent radio connections or communication links as illustrated in FIG. 1 and FIG. 2. Communications over a single communication link occurs between an affiliated STA of a non-AP MLD and an affiliated AP of an associated AP MLD.

Generally, when a non-AP MLD associates with an AIP MLD, a set of communication links is negotiated, wherein each communication link maps an affiliated STA of a non-AP MLD to an affiliated AP of an AP MLD. The mapping of communication links between the non-AP MLD and the AP MLD is fixed while the non-AP MLD is associated to the AIP MLD. If one of the communication links between the AP MLD and the non-AP MLD needs to be changed, the AIP MLD and the non-AP MLD are disassociated, resulting in termination of all communication links and a momentary loss in network connectivity, followed by a re-association establishing the new communications links.

### SUMMARY

The present disclosure relates to multi-link devices (MLDs) including access point (AP) MLDs and non-AP MLDs, and specifically modules, systems and methods for changing a first communication link between a first affiliated station (STA) of a non-AP MLD and a first affiliated AP of an AP MLD to a second communication link between the first affiliated STA of the non-AP MLD and a second affiliated AP of the non-AP MLD, while maintaining a third communication link between a second affiliated STA of the non-AP MLD and a third affiliated AP of the AP MLD. More specifically, the present disclosure provides modules, systems and methods for changing a communication link independent of other communication links allowing for continuous connectivity between a non-AP MLD and an AP MLD.

In a broad aspect, a method includes changing a first communication link between a first affiliated station of a first device and a first affiliated AP of a second device to a second communication link between the first affiliated station of the first device and a second affiliated AP of the second device, while maintaining a third communication link between a second affiliated station of the first device and a third affiliated AP of the second device.

In an embodiment, the method includes activating one or more affiliated APs of the second device from a deactivated state to an activated state upon detection of a proximate first device.

In an embodiment, the method includes the first device sending a communication link configuration request management frame to the second device to request changing the first communication link to the second communication link.

In an embodiment, the method includes the second device sending a communication link configuration response management frame to the first device to confirm changing the first communication link to the second communication link.

In an embodiment, the method includes the second device sending a communication link configuration query management frame to the first device to suggest changing the first communication link to the second communication link.

In an embodiment, the communication link configuration request management frame includes the following fields: category, communication link configuration action, dialog token, current communication link information, and new communication link information.

In an embodiment, the communication link configuration response management frame includes the following fields: category, communication link configuration action, dialog token and new communication link information.

In an embodiment, the communication link configuration query management frame includes the following fields: category, communication link configuration action, dialog token, current communication link information, and new communication link information.

In an embodiment, the communication link configuration response management frame includes group keys of the second affiliated AP for decrypting data of the second affiliated AP.

In an embodiment, the second device is an AP MLD and the first device is a non-AP MLD for a network using an IEEE 802.11 protocol configured for multi-link operation.

In a broad aspect, a module includes a second device having a plurality of affiliated APs, each affiliated AP for establishing a communication link with an affiliated station of a first device, wherein the second device is configured to independently change each communication link between an affiliated AP and an affiliated station.

In a broad aspect, a module includes a first device configured to provide a plurality of affiliated stations, each affiliated station for establishing a communication link with an affiliated AP of a second device, wherein the first device is configured to independently change each communication link between an affiliated station and an affiliated AP.

### BRIEF DESCRIPTION OF THE DRAWINGS

For a more complete understanding of the disclosure, reference is made to the following description and accompanying drawings, in which:

FIG. 1 is a schematic of an embodiment of a prior art pair of multi-link devices (MLDs);

FIG. 2 is a schematic of an embodiment of a prior art pair of MLDs;

FIG. 3 is a schematic of an embodiment of a pair of MLDs comprising an access point (AIP) MLD and an associated non-AP MLD;

FIG. 4 is a schematic of the pair of MLDs of FIG. 3 wherein a communication link between the AP MLD and the non-AP MLD is changed;

FIG. 5 is a schematic of the pair of MLDs of FIG. 4 wherein a communication link between the AP MLD and the non-AP MLD is changed;

FIG. 6 is a flowchart of an embodiment of a method of changing a communication link between an AP MLD and a non-AP MLD;

FIG. 7 is an illustration of an embodiment of a link configuration response management frame;

FIG. 8 is an illustration of an embodiment of a link configuration query management frame;

FIG. 9 is an illustration of an embodiment of a link configuration request management frame;

FIG. 10 is an exemplary schematic of communication flow between an AP MLD and a non-AP MLD for changing a communication link initiated by the non-AP MLD;

FIG. 11 is an exemplary schematic of communication flow between an AP MLD and a non-AP MLD for changing a communication link initiated by the AP MLD;

FIG. 12 is a schematic of an embodiment of a pair of MLDs comprising an AP MLD and an associated non-AP MLD, wherein the AP MLD comprises two disabled affiliated APs;

FIG. 13 is a schematic of the pair of MLDs of FIG. 12 wherein the two disabled affiliated APs are enabled; and

FIG. 14 is a schematic of the pair of MLDs of FIG. 13 wherein a communication link between the AP MLD and the non-AP MLD is changed.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

In embodiments disclosed herein, a network comprises two or more devices that are interconnected through a communication link (by a cable, a wireless connection and/or other means) for sharing resources, information, and/or the like. In embodiments disclosed herein, a multi-link device (MLD) is a device that connects to one or more devices through two or more communication links. In embodiments disclosed herein, a multi-link network is a network comprising one or more MLDs.

The Institute of Electrical and Electronics Engineers (IEEE) is a professional association for electronic and electrical engineering, and is a body responsible for setting communication standards. The IEEE 802.11 standards are a part of IEEE 802 local area network technical standards specifying media access control (MAC) and physical layer (PHY) protocols for implementing wireless local area networks (WLANs). IEEE 802.11be is an amendment to the IEEE 802.11 standard which may include a multi-link operation (MLO) feature wherein two MLDs communicate over one or more, independent radio connections or communication links.

In embodiments disclosed herein, an access point (AP) or wireless AP is a device which acts a portal to other devices to connect to one or more other networks. In some embodiments, the AP provides an interconnection between wireless devices and other wireless/wired networks including the devices thereon. APs are commonly used for extending wireless coverage of an existing network and for increasing the number of users or devices that can connect to a WLAN.

In embodiments disclosed herein, a station (STA) is a device configured to connect to one or more APs. A STA may be fixed, mobile or portable. A STA may also referred to as a wireless client, anode, and/or a transmitter or receiver based on transmission characteristics. IEEE 802.11-2020 specifies that a STA is any device that contains an IEEE 802.11-conformant MAC and PHY interface for connecting to a wireless medium.

In embodiments disclosed herein, a MLD is a network element that communicates with a peer MLD through two or more communication links. A MLD that provides AP functionality is commonly referred to as an AP MLD. A non-AP MLD comprises affiliated STAs for communicating over a wireless medium with affiliated APs in an AP MLD. An MLD can support multiple radios operating simultaneously within multiple bands. MLDs can establish a connection across multiple radios, which connections are referred to as communication links.

“Affiliated” as used herein means a device, component, element and/or the like that is either physically connected to and/or integrated with, or logically connected to another device, component, element and/or the like. As used herein, an affiliated AP may be physically, logically or otherwise connected to or used by an AP MLD, and a reference to an affiliated AP would be equivalent to an AP being affiliated with an AP MLD. Similarly, as used herein, an affiliated STA may be physically, logically or otherwise connected to or used by a non-AP MLD, and a reference to an affiliated STA would be equivalent to a STA being affiliated with a non-AP MLD.

In embodiments disclosed herein, an AP MLD may also be referred to as a multi-link AP, a multi-link AP device, and/or an AP multi-link device. A non-AP MLD associated with a non-AP STA may be referred to as a multi-link STA, a multi-link STA device, or a STA multi-link device.

In embodiments disclosed herein, MLDs support multiple radios simultaneously operating within multiple bands. MLDs may establish connections across multiple radios, which are referred to as communication links. Communications over a single communication link can occur between a STA affiliated with a non-AP MLD and an AP affiliated with an AP MLD.

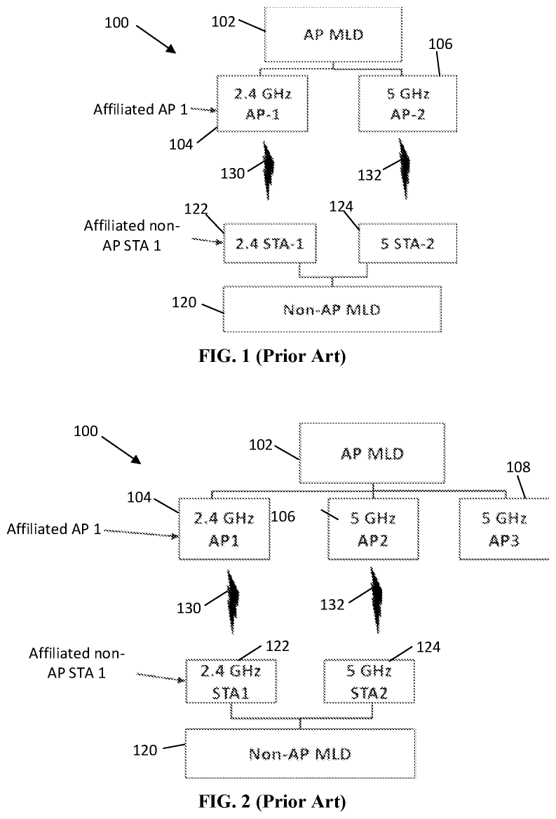

When a non-AP MLD associates with an AP MLD, a set of communication links are negotiated, where each communication link maps an affiliated STA in the non-AP MLD to an affiliated AP in the AP MLD. Generally, the mapping of communication links between a non-AP MLD and AP MLD are fixed while the non-AP MLD is associated with the AP MLD. Referring to FIG. 1, a prior art MLD pair 100, which may form part of a wireless network, comprises an AP MLD 102 and an associated non-AP MLD 120. The AP MLD 102 comprises a first affiliated AP (AP-1) 104 and a second affiliated AP (AP-2) 106 and the non-AP MLD 120 comprises a first affiliated STA (STA-1) 122 and a second affiliated STA (STA-2) 124. The first affiliated AP 104 and the first affiliated STA 122 are configured to operate at 2.4 GHz, while the second affiliated AP 106 and the second affiliated STA 124 are configured to operate at 5 GHz. The first affiliated AP 104 and the first affiliated STA 122 form a first communication link 130 and the second affiliated AP 106 and the second affiliated STA 124 form a second communication link 132. When the AP MLD 102 associates with the non-AP MLD 120, the first communication link 130 and the second connection link 132 are established.

Embodiments disclosed herein relate to systems, methods, and MLD modules, including circuitry and software for executing processes, relating to MLDs. As will be described later in more detail, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As will be described in more detail below, a MLD module may be a part of a device, an apparatus, a system, and/or the like, wherein the MLD module may be coupled to or integrated with other parts of the device, apparatus, or system such that the combination thereof forms the device, apparatus, or system. Alternatively, the MLD module may be implemented as a standalone encryption/decryption device or apparatus.

The MLD module executes processes including those for establishing and changing communication links. Herein, a process has a general meaning equivalent to that of a method, and does not necessarily correspond to the concept of computing process (which is the instance of a computer program being executed). More specifically, a process herein is a defined method implemented using hardware components for processing data (for example, transmitting and receiving management frames, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the MLD processes disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The MLD module may read the computer-executable code from the storage devices and execute the computer-executable code to perform the encryption and/or decryption processes.

Alternatively, the MLD processes disclosed herein may be implemented as one or more hardware structures having necessary electrical and/or optical components, circuits, logic gates, integrated circuit (IC) chips, and/or the like.

FIG. 2 illustrates an embodiment of a prior art MLD pair 100, which may form part of a wireless network, comprising an AP MLD 102 and an associated non-AP MLD 120. The AP MLD 102 comprises three affiliated APs, a first affiliated AP (AP1) 104 configured to operate at 2.4 GHz, a second affiliated AP (AP2) 106 configured to operate at 5 GHz, and a third affiliated AP (AP3) 108 configured to operate at 5 GHz. The non-AP MLD 120 comprises two affiliated STAs, a first affiliated STA (STA1) 122 configured to operate at 2.4 GHz and a second affiliated STA (STA2) 124 configured to operate at 5 GHz. As above, when a non-AP MLD associates with an AP MLD, one or more communication links are negotiated and established between affiliated APs of the AP MLD and affiliated STAs of the non-AP MLD. Referring to FIG. 2, a first communication link 130 is established between the first affiliated AP 104 and the first affiliated STA 122 and a second communication link 132 is established between the second affiliated AP 106 and the second affiliated STA 124, while the third affiliated AP 108 is unconnected and available.

In some embodiments, an AP MLD, a non-AP MLD and/or another device may monitor network conditions to determine if modifying communication links would provide improved quality. For example, this can be a result of monitoring environmental factors such as data traffic flow, packet errors, available APs and STAs, and/or the like. Changes in conditions can also be a result of physical migration of devices, including a non-AP MLD, environmental changes, or other events.

In some embodiments, during operation of the MLD pair 100, it is determined that the third affiliated AP 108 provides a better quality communication link with the second affiliated STA 124 than the second affiliated AP 106. To change a communication link between AP MLD 102 and the associated non-AP MLD 120, disassociation of the AP MLD 102 and the non-AP MLD 120 is first required. Following the disassociation, a re-association between the AP MLD 102 and the non-AP MLD 120 can occur with the new or re-mapped communication links. The disassociation and re-association, or re-negotiation, between the AP MLD 102 and the non-AP MLD 120 results in a temporary loss in network connectivity in both the first communication link 130 and the second communication link 132.

Referring to FIG. 2, to change the second communication link 132 for the second affiliated STA 124 from the second affiliated AP 106 to the third affiliated AP 108, the AP MLD 102 and the non-AP MLD 120 will first disassociate. As previously described, this means that network connectivity is temporarily suspended and the security association between the AP MLD 102 and the non-AP MLD 120 is lost. When the non-AP MLD 120 successfully completes re-association to the AP MLD 102, the first communication link 130 remains between the first affiliated AP 104 and the first affiliated STA 122 and the second communication link 132 is re-mapped from between the second affiliated AP 106 and the second affiliated STA 124 to between the third affiliated AP 108 and the second affiliated STA 124.

In some embodiments disclosed herein, affiliated APs use different group security keys to cryptographically encapsulate group addressed traffic. When the non-AP MLD 120 changes its link mapping with the AP MLD 102, the non-AP MLD 120 needs to receive updated group keys based on the new communication link mapping. As a result of the re-mapping described above, a new security association is established between the AP MLD 102 and the non-AP MLD 120.

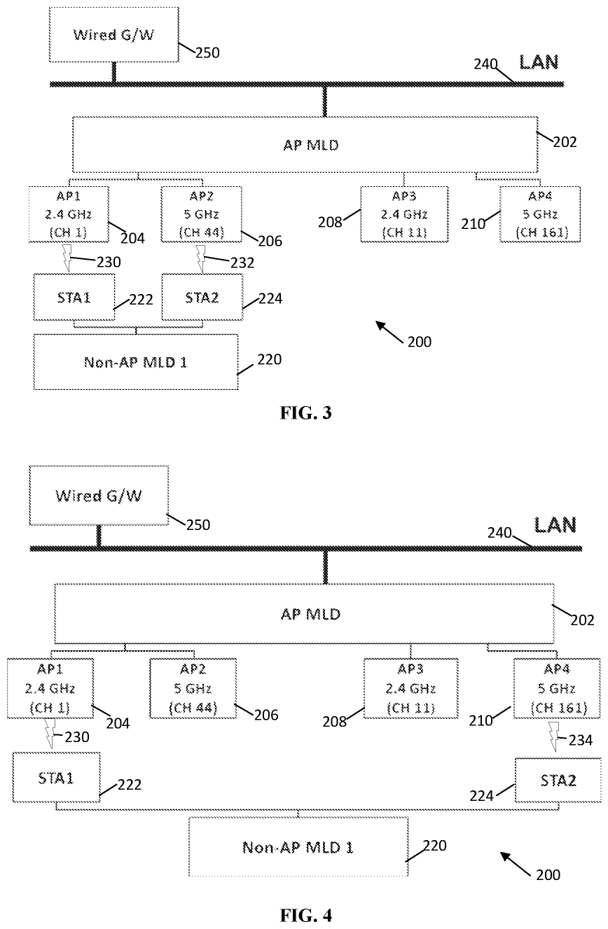

Referring to FIG. 3, in embodiments of the present disclosure, an MLD pair 200, which may form part of a wireless network, comprises an AP MLD 202 and a non-AP MLD 220. The AP MLD comprises a first affiliated AP (AP1) 204 configured to operate at 2.4 GHz, a second affiliated AP (AP2) 206 configured to operate at 5 GHz, a third affiliated AP (AP3) 208 configured to operate at 2.4 GHz and a fourth affiliated AP (AP4) 210 configured to operate at 5 GHz. The non-AP MLD 220 comprises a first affiliated STA (STA1) 222 and a second affiliated STA (STA2) 224. In embodiments disclosed herein, the MLD pair 200 is connected to a local area network (LAN) 240, which may be connected to one or more other devices including a wired gateway 250.

While FIG. 3 depicts one AP MLD 202, a wireless network can comprise any number of additional AP MLDs and additional non-AP MLDs, each AP MLD comprising one or more affiliated APs wherein each AP is configured to operate at one or more operating frequencies and each non-AP MLD comprising one or more affiliated STAs wherein each affiliated STA is configured to operate at one or more operating frequencies.

In embodiments disclosed herein, the non-AP MLD 220 can change communication link mapping of the first affiliated STA 222 or the second affiliated STA 224 with affiliated APs of the AP MLD 202 using a message exchange that takes place while the non-AP MLD remains associated without a corresponding loss of network connectivity, wherein the message exchange occurs over the unchanged communication link.

By updating the mapping of communication links of affiliated STAs, the non-AP MLD 220 can optimize the usage of the multiple radio resources of the AP MLD 202. In embodiments disclosed herein, group keys associated with new communication link mappings can also be updated using the message exchange. Further, the AP MLD 202 can also manage its radio resources more efficiently by suggesting to one or more associated non-AP MLDs to change their communication links dynamically to optimize performance, using the message exchange.

Referring to FIG. 3, in embodiments disclosed herein, the AP MLD 202 comprises two affiliated APs operating at 2.4 GHz, the first affiliated AP 204 and the third affiliated AP 208 and two affiliated APs operating at 5 GHz, the second affiliated AP 206 and the fourth affiliated AP 210. In an embodiment, the first affiliated STA 222 of the non-AP MLD 220 is configured to operate at 2.4 GHz and the second affiliated STA 224 of the non-AP MLD 220 is configured to operate at 5 GHz. Referring to FIG. 3, in an embodiment, the AP MLD 202 and the non-AP MLD 220 are associated wherein a first communication link 230 is established between the first affiliated AP 204 and the first affiliated STA 222 and a second communication link 232 is established between the second affiliated AP 206 and the second affiliated STA 224.

In embodiments disclosed herein, an AP MLD of a plurality of AP MLDs is distributed throughout a coverage area with the AP MLD comprising multiple affiliated APs. This may be an example of an AP MLD forming part of a WLAN within an enterprise or a large home. In embodiments, disclosed herein, a non-AP MLD (with fewer affiliated STAs than the number of affiliated APs in the AP MLD) associates to the AP MLD. The MLD pair 200 of FIG. 3 comprises four available affiliated APs in the AP MLD 202.

As the non-AP MLD 220 moves within a coverage zone of the AP MLD 202 or the wireless environment changes, the non-AP MLD 220 may change its communication link configuration to use other affiliated APs of the same AP MLD 220, while maintaining its association with the AP MLD 202, to optimize its communication link quality.

In an exemplary embodiment, referring to FIG. 3, after association between the AP MLD 202 and the non-AP MLD 220, the first communication link 230 is established between the first affiliated AP 204 and the first affiliated STA 222 and the second communication link 232 is established between the second affiliated AP 206 and the second affiliated STA 224. Of note, the third affiliated AP 208 and the fourth affiliated AP 210 are not mapped to affiliated STAs of the non-AP MLD 220.

As a result of physical movement, environmental changes, or other events, the non-AP MLD 220 initiates a change of the second communication link 232. Referring to FIG. 4, the second affiliated STA 224 is associated with the fourth affiliated AP 210 to establish a third communication link 234. Notably, the first communication link 230 between the first affiliated AP 204 and the first affiliated STA 222 is maintained during the transition from the second communication link 232 to the third communication link 234 such that communication between the AP MLD 202 and the non-AP MLD 220 is maintained including for message exchanges. After the transition from the second communication link 232 to the third communication link 234, the second affiliated AP 206 is no longer mapped to an affiliated STA of the AP MLD 202.

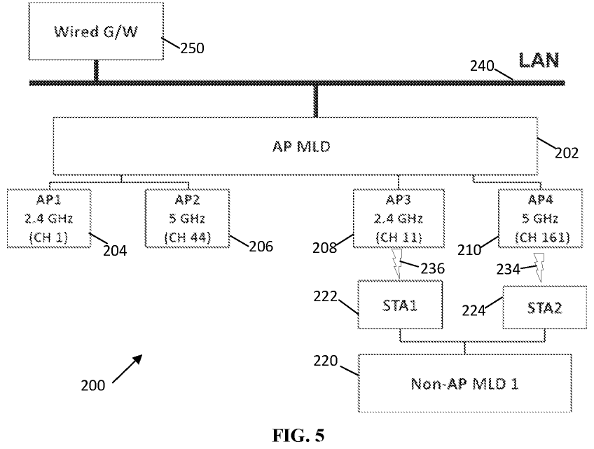

As a result of further physical movement, environmental changes, or other events, the non-AP MLD 220 initiates a change of the first communication link 230. Referring to FIG. 5, the first affiliated STA 222 is associated with the third affiliated AP 208 to establish a fourth communication link 234. Notably, the third communication link 234 between the fourth affiliated AP 210 and the second affiliated STA 224 is maintained during the transition from the first communication link 230 to the fourth communication link 236 such that communication between the AP MLD 202 and the non-AP MLD 220 is maintained including for message exchanges. After the transition from the first communication link 230 to the fourth communication link 236, the first affiliated AP 204 is no longer mapped to an affiliated STA of the AP MLD 202.

The methods disclosed herein may be applied to Directional Multi-Gigabit (DMG), China Directional Multi-Gigabit (CDMG) and Enhanced Directional Multi-Gigabit (EDMG) communication links, wherein coverage areas are often limited and the affiliated APs supporting the applicable frequency bands use highly directional antennas.

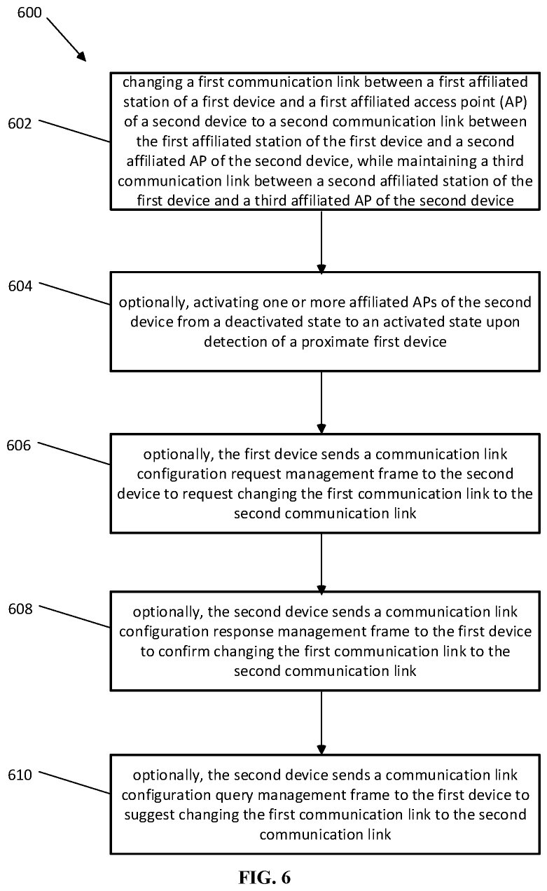

FIG. 6 illustrates the steps of an embodiment of a method 600 of changing a communication link of an AP MLD 202 and a non-AP MLD 220. The method 600 begins with changing a first communication link between a first affiliated station of a first device and a first affiliated AP of a second device to a second communication link between the first affiliated station of the first device and a second affiliated AP of the second device, while maintaining a third communication link between a second affiliated station of the first device and a third affiliated AP of the second device at step 602. At step 604, optionally, one or more affiliated APs of the second device are activated from a deactivated state to an activated state upon detection of a proximate first device. At step 606, optionally, the first device sends a communication link configuration request management frame to the second device to request changing the first communication link to the second communication link. At step 608, optionally, the second device sends a communication link configuration response management frame to the first device to confirm changing the first communication link to the second communication link. At step 610, optionally, the second device sends a communication link configuration query management frame to the first device to suggest changing the first communication link to the second communication link.

When a non-AP MLD associates to an AP MLD, the association results in a mapping of affiliated AP to affiliated STA communication links. Link IDs are assigned by the AP MLD and map AP MAC addresses to STA MAC addresses.

The IEEE 802.11 standard generally uses three types of frames: management, control and data. Management frames are generally used to manage a basic service set, control frames control access to a medium, and data frames contain payloads of information. Managing of the basic service set includes probing, associating, roaming and disconnecting clients from the basic service set. In embodiments disclosed herein, message exchanges relating to changing communication links between the AP MLD 202 and the non-AP MLD 220 are in the form of management frames.

The re-mapping of communication links described above as illustrated in FIG. 3 to FIG. 5 requires updating of the communication link mapping. In embodiments disclosed herein, this is accomplished using three management frames: a link configuration request management frame, a link configuration response management frame, and a link configuration query management frame. The link configuration request management frame is transmitted by a non-AP MLD to an AP MLD to request a configuration change to one or more of its communication links. The link configuration response management frame is transmitted by an AP MLD to respond to a link configuration request management frame received from a non-AP MLD to change its communication link configuration. The link configuration query management frame is transmitted by an AP MLD to suggest that a non-AP MLD change its communication link configuration to a recommended new communication link mapping. A non-AP MLD that receives a link configuration query management frame can send a link configuration request management frame to change a communication link configuration based on the recommendation.

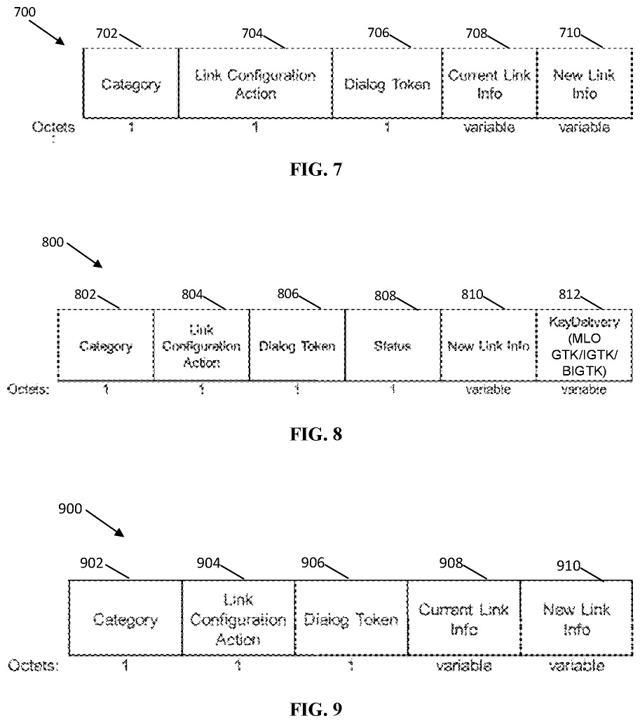

FIG. 7 illustrates an exemplary frame format of a link configuration request management frame 700 comprising the following fields: category 702, link configuration action 704, dialog token 706, current link info 708 and new link info 710. The category field 702 is set to the link configuration value in table 9-79 of IEEE 802.11-2020. The link configuration action field 704 is set to 0 for the link configuration request frame 700. The dialog token field 706 can be set to any integer between 0 and 255. The current link info field 708 comprises a basic variant of the multi-link element of IEEE 802.11be D1.5 which conveys the current mapping for each communication link. The new link info field 710 comprises a basic variant of the multi-link element which conveys the requested mapping for each communication link.

FIG. 8 illustrates an exemplary frame of a link configuration response management frame 800 comprising the following fields: category 802, link configuration action 804, dialog token 806, status 808, new link info 810 and key delivery 812. The category field 802 is set to the link configuration value in table 9-79 of IEEE 802.11-2020). The link configuration action field 804 is set to 1. The dialog token field 806 can be set to any integer between 0 and 255. The status field 808 indicates the result of the request, which can be: success, denied, or a new mapping suggestion. The new link info field 810 is conditionally present when the result of the request is a new mapping suggestion and comprises a basic variant of multi-link element which conveys a suggested alternative mapping. Note that the suggested alternative would require a non-AP MLD to transmit a new link configuration request frame.

An AP MLD could optionally include an update to the cryptographic material such as keys of Group Temporal Key (GTK), Integrity Group Temporal Key (IGTK), Beacon Integrity Group Temporal Key (BIGTK) associated with that communication link. These keys can be included in the key delivery (KeyDelivery) field 812 in a Key Delivery Element (KDE) defined in the IEEE 802.11 standard in clause 9.4.2.185.

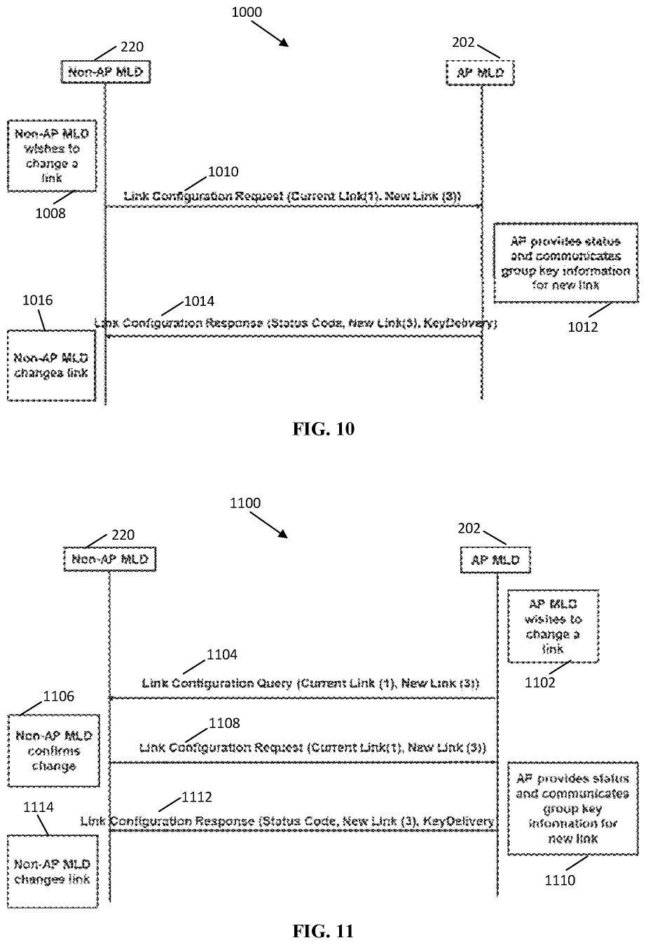

FIG. 9 illustrates an exemplary frame of a link configuration query frame 900 comprising the following fields: category 902, link configuration action 904, dialog token 906, current link info 908, and new link info 910. The category field 902 is set to the link configuration value in table 9-79 of IEEE 802.11-2020. The link configuration action field 904 is set to 2 for the query frame. The dialog token field 906 can be set to any integer between 0 and 255. The current link info field 908 comprises a basic variant of the multi-link element conveying the current mapping for each communication link. The new link info field 910 comprises a basic variant of the multi-link element conveying the requested mapping for each communication link. Note that the suggested alternative would require a non-AP MLD to issue a new link configuration request frame to request changes to its link mapping.

FIG. 10 illustrates an exemplary method 1000 for reconfiguring communication links between a non-AP MLD 220 and an AP MLD 202 using management frames, wherein the communication link change is initiated by the non-AP MLD 220. The method 1000 begins with the non-AP MLD 220 identifying a communication link change at step 1008. At step 1010, a link configuration request management frame is transmitted from the non-AP MLD 220 to the AP MLD 202. At step 1012, the AP MLD provides status and communicates group key information for the new communication link. At step 1014, a link configuration response management frame is transmitted from the AP MLD 202 to the non-AP MLD 220. At step 1016, the non-AP MLD 220 updates the communication link.

In an exemplary embodiment, referring to FIG. 10, the AP MLD 202 may initiate a communication link re-configuration by sending a link configuration request management frame to the non-AP MLD 220, which then sends a link configuration response management frame. Group key updates could either be included in the link configuration request management frame from the AP MLD 202, or in another message.

FIG. 11 illustrates an exemplary method 1100 for reconfiguring communication links between a non-AP MLD 220 and an AP MLD 202 using management frames, wherein the communication link change is initiated by the AP MLD 202. The method 1100 begins with the AP MLD 202 identifying a communication link change at step 1102. At step 1104, a link configuration query management frame is transmitted from the AP MLD 202 to the non-AP MLD 220. At step 1106, the non-AP MLD 220 confirms the communication link change. At step 1108, a link configuration request management frame is transmitted from the non-AP MLD 220 to the AP MLD 202. At step 1110, the AP MLD provides status and communicates group key information for the new communication link. At step 1112, a link configuration response management frame is transmitted from the AP MLD 202 to the non-AP MLD 220. At step 1114, the non-AP MLD 220 updates the communication link.

In embodiments disclosed herein affiliated APs use different group keys to cryptographically encapsulate group addressed traffic. In embodiments disclosed herein, when a non-AP MLD changes its communication link mapping with an AP MLD, the non-AP MLD needs to receive updated group keys (with the remainder of the security association between the non-AP MLD and the AP MLD not changing) in order to successfully receive group addressed traffic on that communication link.

In embodiments, KDEs are included in the link configuration response management frame 800 to update cryptographic material (e.g. group keys) without requiring an additional protocol exchanges (e.g. Group Key handshakes) for cryptographic material associated with each new communication link.

In embodiments disclosed herein, two or more affiliated APs of an AP MLD can also be deployed in the same location, physically co-located or distributed with similar coverage. Affiliated APs of an AP MLD can be dynamically disabled/enabled depending on operating conditions. For example, some affiliated APs could be configured to have dedicated service modes (e.g. 6 GHz, Emergency Preparedness Communications Service (EPSC), or Enhanced Broadcast Services (EBCS) only). In another example, Millimetre Wave (mmWave) APs (e.g. DMG, EDMG, CDMG) could be dynamically enabled when a non-AP MLD is in their proximity.

In embodiments disclosed herein, a non-AP MLD establishes multiple communications links using affiliated STAs, with distributed, affiliated APs. Further, communication links can be re-mapped depending on service conditions.

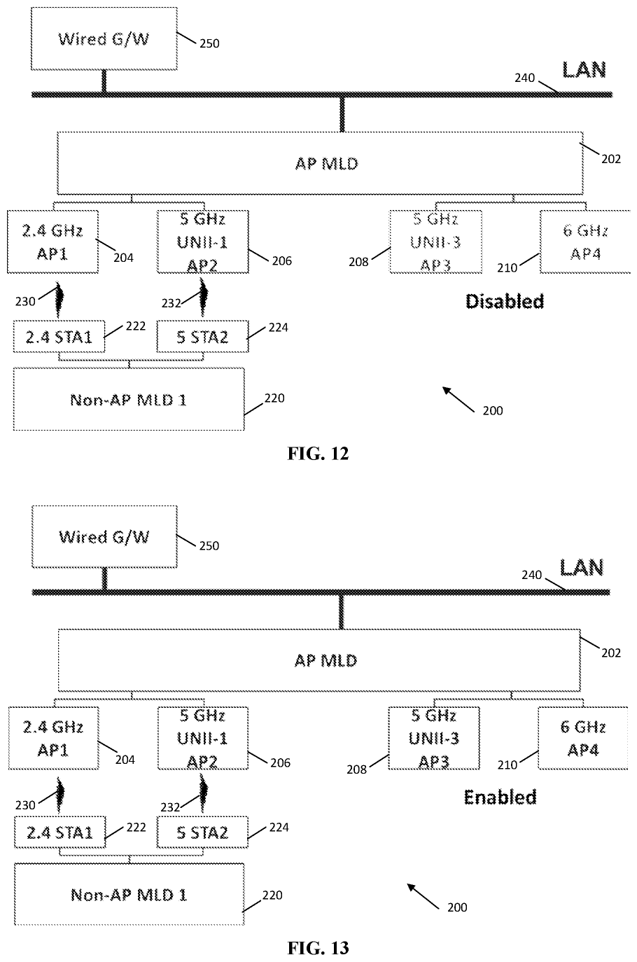

In an exemplary embodiment, a non-AP MLD 220 may change a communication link from a 5 GHz UNII 1 band to a 5 GHz UNII 3 band, as illustrated in FIG. 12 to FIG. 14, wherein in embodiments of the present disclosure, an MLD pair 200 comprises an AP MLD 202 and a non-AP MLD 220. The AP MLD comprises a first affiliated AP (AP1) 204 configured to operate at 2.4 GHz, a second affiliated AP (AP2) 206 configured to operate in a 5 GHz UNII 1 band, a third affiliated AP (AP3) 208 configured to operate in a 5 GHz UNII 3 band, and a fourth affiliated AP (AP4) 210 configured to operate at 6 GHz. The non-AP MLD 220 comprises a first affiliated STA (STAT) 222 and a second affiliated STA (STA2) 224. In embodiments disclosed herein, the MLD pair 200 is connected to a local area network (LAN) 240, which may be connected to one or more other devices including a wired gateway 250.

In FIG. 12, a first communication link 230 is established between the first affiliated AP 204 and the first affiliated STA 222, a second communication link 232 is established between the second affiliated AP 206 and the second affiliated STA 224, while the third affiliated AP 208 and the fourth affiliated AP 210 are disabled.

In FIG. 13, the AP MLD 202 enables the third affiliated AP 208 and the fourth affiliated AP 210, and the non-AP MLD 220 determines that the third affiliated AP 208 provides better service than the second affiliated AP 206. As a result, the non-AP MLD 220 transmits a link configuration request management frame 700 to the AP MLD 202 requesting a change in its communication link mapping. Where an AP MLD comprises affiliated APs that support mmWave technology (e.g. DMG, EDMG, or CDMG) and a non-AP MLD supports this technology, the non-AP MLD can use the above disclosed methods to initiate the non-AP MLD to update its configuration to establish connectivity over the mmWave capable affiliated AP.

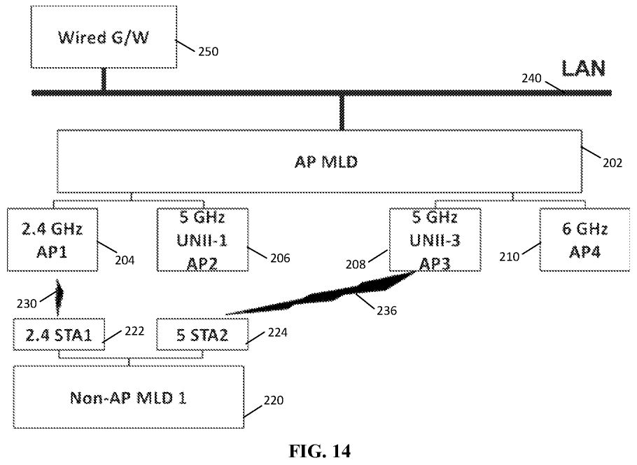

Referring to FIG. 14, the second affiliated STA 224 associates with the third affiliated AP 208 to establish a third communication link 236. Notably, the first communication link 230 between the first affiliated AP 204 and the first affiliated STA 222 is maintained during the transition from the second communication link 232 to the third communication link 236 such that communication between the AP MLD 202 and the non-AP MLD 220 is maintained. After the transition from the second communication link 232 to the third communication link 236, the second affiliated AP 206 is no longer mapped to an affiliated STA of the AP MLD 202. Note that in this embodiment, the AP MLD 202 that deploys new resources by enabling the third affiliated AP 208 and the fourth affiliated AP 210.

Although embodiments have been described above with reference to the accompanying drawings, those of skill in the art will appreciate that variations and modifications may be made without departing from the scope thereof as defined by the appended claims.

1. A method comprising:
changing a first communication link between a first affiliated station of a first device and a first affiliated access point (AP) of a second device to a second communication link between the first affiliated station of the first device and a second affiliated AP of the second device, while maintaining a third communication link between a second affiliated station of the first device and a third affiliated AP of the second device.

2. The method of claim 1 further comprising the step of:
activating one or more affiliated APs of the second device from a deactivated state to an activated state upon detection of a proximate first device.

3. The method of claim 1 further comprising the step of:
the first device sending a communication link configuration request management frame to the second device to request changing the first communication link to the second communication link.

4. The method of claim 3 further comprising the step of:
the second device sending a communication link configuration response management frame to the first device to confirm changing the first communication link to the second communication link.

5. The method of claim 3 further comprising the step of:
the second device sending a communication link configuration query management frame to the first device to suggest changing the first communication link to the second communication link.

6. The method of claim 3, wherein the communication link configuration request management frame comprises the following fields: category, communication link configuration action, dialog token, current communication link information, and new communication link information.

7. The method of claim 4, wherein the communication link configuration response management frame comprises the following fields: category, communication link configuration action, dialog token and new communication link information.

8. The method of claim 5, wherein the communication link configuration query management frame comprises the following fields: category, communication link configuration action, dialog token, current communication link information, and new communication link information.

9. The method of claim 7, wherein the communication link configuration response management frame further comprises group keys of the second affiliated AP for decrypting data of the second affiliated AP.

10. The method of claim 1, wherein the second device is an AP multi-link device (MLD) and the first device is a non-AP MLD for a network using an IEEE 802.11 protocol configured for multi-link operation.

11. A module comprising:
a second device comprising a plurality of affiliated APs, each affiliated AP for establishing a communication link with an affiliated station of a first device, wherein the second device is configured to independently change each communication link between an affiliated AP and an affiliated station.

12. The module of claim 11, wherein the second device is configured to send a communication link configuration query management frame to a first device to suggest changing a communication link.

13. The module of claim 12, wherein the second device is configured to send the communication link configuration query management frame upon detection of increased packet errors, environmental conditions, or other events supporting changing the communication link.

14. The module of claim 11, wherein the second device is configured to send a communication link configuration response management frame to a first device to confirm changing a communication link.

15. The module of claim 14, wherein the communication link configuration response management frame comprises group keys of an affiliated AP for decrypting information of the affiliated AP.

16. The module of claim 11, wherein one or more of the affiliated APs is configured to activate upon detection of a proximate first device.

17. The module of claim 11, wherein one or more of the affiliated APs is configured to operate in a dedicated service mode.

18. A module comprising:
a first device configured to provide a plurality of affiliated stations, each affiliated station for establishing a communication link with an affiliated AP of a second device, wherein the first device is configured to independently change each communication link between an affiliated station and an affiliated AP.

19. The module of claim 18, wherein the first device is configured to send a communication link configuration request management frame to a second device to request changing a communication link.

20. The module of claim 19, wherein the first device is configured to send the communication link configuration request management frame upon detection of increased packet errors, environmental conditions, or other events supporting changing the communication link, or newly available affiliated APs.
